(19) United States
(12) Patent Application Publication
(10) Pub. No.: US 2013/0149929 A1
(43) Pub. Date: Jun. 13, 2013

(54) LOW FORMALDEHYDE AND HIGH WET STRENTGH VINYL ACETATE ETHYLENE DISPERSIONS

(71) Applicants: John Richard Boylan, Bethlehem, PA (US); Dennis Sagl, Fogelsville, PA (US)

(72) Inventors: John Richard Boylan, Bethlehem, PA (US); Dennis Sagl, Fogelsville, PA (US)

(73) Assignee: Wacker Chemical Corporation, Adrian, MI (US)

(21) Appl. No.: 13/313,467

(22) Filed: Dec. 7, 2011

(51) Int. Cl. B32B 5/02; B05D 3/00; C08L 33/26; B05D 7/24; C08L 29/04; C08L 31/04

(52) U.S. Cl. 442/59; 524/503; 427/385.5

(57) ABSTRACT

An aqueous composition includes a blend of:
a) an aqueous dispersion of an N-methylol-containing vinyl acetate ethylene or vinyl acetate polymer, stabilized by polyvinyl alcohol and optionally also by a surfactant, wherein N-methylol-containing monomer units constitute from 0.025 to 0.4 wt % of the polymer; and
b) an acid.

The invention provides a method of increasing the wet strength of a fibrous nonwoven substrate, including applying to the substrate the above aqueous composition, followed by a drying step. A fibrous nonwoven article is thereby provided.

### BACKGROUND OF THE INVENTION

Vinyl acetate ethylene (VAE) copolymer and vinyl acetate (VA) homopolymer dispersions containing N-methylolacrylamide (NMA) as a self-crosslinking functional monomer are often applied to nonwoven substrates to provide good dry and wet tensile strength, as well as good water absorptivity. Examples of such substrates include airlaid nonwoven substrates used for wet wipe end-use applications. Wet wipes have an aqueous composition, such as a lotion, impregnated into the substrate to afford a wet texture, and therefore must have good wet tensile strength.

During the NMA crosslinking, however, formaldehyde is produced as an undesirable by-product. In addition, in many cases formaldehyde is also present in the dispersion prior to crosslinking due to the use of sodium formaldehyde sulfoxylate (SFS) as a redox radical initiator in forming the VAE copolymer. Formaldehyde may also be present due to the use of certain preservatives. The presence of formaldehyde in the dispersion, as well as in the substrate after the crosslinking reaction, is, however, undesirable for both the manufacturer of the substrate as well as the end use consumer. Efforts to use VAE or VA resins not containing NMA or other crosslinking monomers, however, have typically resulted in insufficient wet tensile strength. Thus, a need exists for methods and compositions capable of providing acceptable wet and dry tensile strength while minimizing generation of formaldehyde.

U.S. Pat. No. 3,380,851 describes nonwoven fabrics formed by bonding the fibers with a binder composed of a vinyl acetate-ethylene-N-methylol acrylamide copolymer, comprising 0.5 to 10% by weight of N-methylol acrylamide (NMA) based on the weight of vinyl acetate. The copolymer is polymerized in the presence of emulsifiers, optionally in the presence of a protective colloid like polyvinyl alcohol. Acid catalysts, including acid salts such as ammonium chloride, may be applied for promoting crosslinking via the NMA units.

U.S. Pat. No. 4,449,978 discloses nonwoven products having formaldehyde content of less than 50 ppm in the nonwoven. In the nonwoven binder N-methylol acrylamide is partially substituted by acrylamide. Ammonium chloride is disclosed as a suitable catalyst for inducing crosslinking of the N-methylol units.

U.S. Pat. No. 4,698,384 describes a copolymer emulsion for bonding nonwovens that is based on a protective colloid stabilized aqueous dispersion. For the improvement of solvent resistance of the bonded nonwovens binders, the inventors use a vinyl acetate ethylene copolymer with an ethylene content of 5 to 35 wt % and 2 to 10 wt % of N-methylol acrylamide or its derivatives, which is polymerized in the presence of 0.1 to 1 wt % of polyvinyl pyrrolidone.

In U.S. Pat. No. 5,143,954 a nonwoven binder with low-formaldehyde is described, employing an N-methylol functional polymer latex and a formaldehyde-scavenging agent.

U.S. Pat. No. 5,540,987 describes reduction of free formaldehyde content by using a particular initiator system during polymerization comprising a hydrophobic hydroperoxide and ascorbic acid. The reduction in free formaldehyde comes from the use of the this non-formaldehyde reducing agent vs a formaldehyde generating reducing agent such as sodium formaldehyde sulfoxylate.

U.S. Pat. No. 6,787,594 discloses a reduced formaldehyde nonwoven binder based on a vinyl acetate-ethylene copolymer with 0.5 to 10 wt % of N-methylol acrylamide, which is polymerized in the presence of redox initiator combination with a glycolic acid adduct of sodium sulfite as the reducing agent.

Despite the abovementioned advances, there remains a need for simple and costeffective ways of providing dry and wet tensile strength to nonwovens while reducing the amount of formaldehyde generated.

### SUMMARY OF THE INVENTION

In one aspect the invention provides an aqueous composition including a blend of:

a) an aqueous dispersion of an N-methylol-containing vinyl acetate ethylene or vinyl acetate polymer, stabilized by polyvinyl alcohol and optionally also by a surfactant, wherein N-methylol-containing monomer units constitute from 0.025 to 0.4 wt % of the polymer; and

b) an acid.

In another aspect, the invention provides a method of increasing the wet strength of a fibrous nonwoven substrate, including applying to the substrate the abovementioned aqueous composition, followed by a drying step.

In yet another aspect, the invention provides a fibrous nonwoven article made by the immediately foregoing method.

### DETAILED DESCRIPTION OF THE INVENTION

The inventors have now found that the issue of high formaldehyde production, typically found with NMA-containing dispersions, may be greatly diminished by use of compositions according to the invention. These compositions include a polyvinyl alcohol stabilized vinyl acetate (VA) or vinyl acetate ethylene polymer (VAE) having a very low level of an N-methylol-containing monomer (e.g., NMA), catalyzed with an acid prior to or shortly after application to a nonwoven. The compositions provide a nonwoven or paper with very low formaldehyde emission and good wet tensile breaking strength.

The invention provides a reduced formaldehyde nonwoven binder comprising a) an aqueous polymer dispersion obtained by emulsion polymerization of vinyl acetate (and optionally ethylene) with 0.025 to 0.4 wt % of an N-methylol-functional comonomer, based in each case on the total weight of the comonomers, in the presence of a partially hydrolyzed or fully hydrolyzed polyvinyl alcohol, and b) a low addition level of an acid.

Both VA and VAE dispersions are suitable for use according to the invention, but for simplicity the dispersion or polymer may be referred to herein as a VAE dispersion or polymer and it will be understood that such use of the term “VAE” includes VA unless the context clearly indicates otherwise.

In general the vinyl acetate fraction is 66% to 99.95% by weight, preferably 68% to 95% by weight, more preferably 68% to 93% by weight, and most preferably 68% to 92% by weight, based in each case on the total weight of the vinyl acetate and ethylene monomers. The ethylene fraction is preferably 0% to 34% by weight, more preferably 2% to 32% by weight and most preferably 5% to 32% by weight, based in each case on the total weight of the comonomers.

Optionally, in some embodiments the range of available properties for the polymer in the dispersion may be extended by copolymerizing additional comonomers with vinyl acetate, or with vinyl acetate and ethylene. Typically, suitable comonomers are monomers with a single polymerizable olefinic group. Examples of such comonomers are vinyl esters of carboxylic acids having 3 to 18 C atoms. Preferred vinyl esters are vinyl propionate, vinyl butyrate, vinyl 2-ethylhexanoate, vinyl laurate, 1-methyl vinyl acetate, vinyl pivalate, and vinyl esters of a-branched monocarboxylic acids having 9 to 11 C atoms, examples being VEOVA9TM or VEOVA10TM esters (available from Momentive Specialty Chemicats, Houston, Tex.). Other suitable comonomers include esters of acrylic acid or methacrylic acid with unbranched or branched alcohols having 1 to 15 C atoms. Exemplary methacrylic esters or acrylic esters include methyl acrylate, methyl methacrylate, ethyl acrylate, ethyl methacrylate, propyl acrylate, propyl methacrylate, n-butyl acrylate, n-butyl methacrylate, 2-ethylhexyl acrylate and norbornyl acrylate. Other suitable comonomers include vinyl halides such as vinyl chloride, or olefins such as propylene. In general the further comonomers are copolymerized in an amount of 0.5 to 30 wt %, preferably 0.5 to 20 wt %, based on the total amount of comonomers in the copolymer.

Optionally, 0.05% to 10% by weight, based on the total amount of vinyl acetate and ethylene, of other monomers (auxiliary monomers) may additionally be copolymerized in forming the dispersion. Auxiliary monomers include a polymerizable olefinic group and at least one additional functional group, which may be an additional polymerizable olefinic group so as to provide crosslinking. Other functional groups may include reactive groups such as carboxylic or sulfonic acid groups.

Examples of auxiliary monomers are ethylenically unsaturated monocarboxylic and dicarboxylic acids, typically acrylic acid, methacrylic acid, fumaric acid and maleic acid; ethylenically unsaturated carboxamides and carbonitriles, typically acrylamide and acrylonitrile; monoesters and diesters of fumaric acid and maleic acid, such as the diethyl and diisopropyl esters, and also maleic anhydride, ethylenically unsaturated sulphonic acids and their salts, typically vinylsulphonic acid, 2-acrylamido-2-methylpropanesulphonic acid. Other examples are pre-crosslinking comonomers such as polyethylenically unsaturated comonomers, examples being divinyl adipate, diallyl maleate, allyl methacrylate or triallyl cyanurate. Also suitable are epoxy-functional comonomers such as glycidyl methacrylate and glycidyl acrylate. Other examples are silicon-functional comonomers, such as acryloyloxypropyltri(alkoxy)- and methacryloyloxypropyltri(alkoxy)silanes, vinyltrialkoxysilanes and vinylmethyldialkoxysilanes, alkoxy groups that may be present being, for example, methoxy, ethoxy and ethoxypropylene glycol ether radicals. Additional monomers comprise hydroxyl or CO groups, examples being methacrylic and acrylic hydroxyalkyl esters such as hydroxyethyl, hydroxypropyl or hydroxybutyl acrylate or methacrylate, and also compounds such as diacetoneacrylamide and acetylacetoxyethyl acrylate or methacrylate.

While some applications may favor the inclusion of additional monomers in the VAE, for example such as those listed above, it may nonetheless in some cases be advantageous to exclude certain monomers in making the polymeric binder, depending on the specific needs of a given application. In other cases, these monomers may be included up to a limit of 1.0 wt % of the polymeric binder. The excluded or limited monomers may include any one or more of the following: i-butoxy methylacrylamide; acrylamidoglycolic acid; acrylamidobutyraldehyde; dialkyl acetals of acrylamidobutyraldehyde; glycidyl-containing compounds (e.g., glycidyl(meth)acrylate, triglycidyl isocyanurate, etc.); ethylenically unsaturated phosphates, phosphonates or sulfates; ethylenically unsaturated silicon compounds; methacrylamide, (meth)acrylic esters; vinyl ethers; acrylonitrile; butadiene; styrene; vinyltoluene; divinyl benzene and/or other olefinically unsaturated hydrocarbons other than ethylene; halogenated monomers (e.g., vinyl chloride); and esters of allyl alcohol.

### N-Methylol-Functional Monomers

Suitable N-methylol-functional comonomers for making the polymer are for example N-methylolacrylamide (NMA), N-methylolmethacrylamide, allyl N-methylolcarbamate, the alkyl ethers such as isobutyl ether, or esters of N-methylolacrylamide, of N-methylol-methacrylamide or of allyl N-methylolcarbamate. N-methylolacrylamide and N-methylol-methacrylamide are particularly preferred.

In a preferred embodiment, N-methylol acrylamide is used in combination with acrylamide. These may be provided as a blend, one commercially available example being a 48% aqueous solution of NMA and acrylamide in a 1:1 molar ratio, available under the tradename CYLINK® NMA-LF MONOMER (Cytec Industries, Woodland Park, N.J.). Alternatively, the NMA and acrylamide may be added separately to the polymerization feed. Suitable amounts of NMA, relative to the total of NMA plus acrylamide, are in a range of 20 mol % to 80 mol %, or in a range of 30 mol % to 70 mol %, or 40 mol % to 60 mol %.

The fraction of the N-methylol-functional comonomer in the polymer is in general 0.025 to 0.4 wt %, preferably 0.025 to 0.2 wt %, most preferred 0.025 to 0.1 wt %, based in each case on the total weight of all comonomers. In some embodiments the amounts of NMA and acrylamide are selected such that the formaldehyde level of the final dispersion is below 10 ppm, preferably below 5 ppm, as measured according to ASTM D5910-96.

In some embodiments of the invention, only VA homopolymers and/or VAE copolymers including methylol-containing monomer(s) but no further comonomer units or auxiliary monomers are used in making the dispersion.

The choice of monomers or the choice of the proportions by weight of the comonomers is preferably made in such a way that, in general, a glass transition temperature Tg of from −30° C. to +35° C. results. The glass transition temperature Tg of the polymers can be determined in a known way by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n and Tgn is the glass transition temperature in kelvin of the homopolymer of the monomer n. Tg values for homopolymers are given in the Polymer Handbook 2nd Edition, J. Wiley & Sons, New York (1975).

### Polyvinyl Alcohol (PVOH)

Polyvinyl alcohols are partially hydrolysed or fully hydrolysed polyvinyl acetates having an average degree of hydrolysis of 80 to 99.9 mol %. Suitable PVOH for use in preparing the dispersion may include ultra-low viscosity (3-4 cps for a 4% aqueous solution), low viscosity (5-6 cps for a 4% aqueous solution), medium viscosity (22-30 cps for a 4% aqueous solution) and high viscosity (45-72 cps for a 4% aqueous solution) varieties. Ultra-low viscosity PVOH has a mass-average degree of polymerization of 150-300 and a weight average molecular weight of 13,000-23,000. Low viscosity PVOH has a mass-average degree of polymerization of 350-650 and a weight average molecular weight of 31,000-50,000. Medium viscosity PVOH has a mass-average degree of polymerization of 1000-1500 and a weight average molecular weight of 85,000-124,000. High viscosity PVOH has a mass-average degree of polymerization of 1600-2200 and a weight average molecular weight of 146,000-186,000. Any polyvinyl alcohol (PVOH) may be used according to the invention. In some embodiments, the viscosity of the PVOH is ultra-low, low or medium.

Weight average molecular weight and degree of polymerization of polyvinyl alcohol is typically determined by using size exclusion chromatography/gel permeation chromatography measurement techniques. Viscosity of polyvinyl alcohol is typically measured on a 4% solids aqueous solution of the PVOH using a Höppler falling-ball viscometer (DIN 53 015) or an Ubbelohde viscometer (capillary viscometer, DIN 51 562 and DIN 53 012). It is international practice to state the viscosity of 4% aqueous polyvinyl alcohol solutions at 20° C.

In some embodiments, suitable examples of PVOH include partially hydrolysed polyvinyl acetates or mixtures of having an average degree of hydrolysis of 80 to 96 mol %. Particular preference is given to partially hydrolysed polyvinyl acetate having an average degree of hydrolysis of 86 to 90 mol %, typically in each case having a mass-average degree of polymerization of 150 to 2200. To adjust the viscosity of the resulting polymer dispersion it may be advantageous to use mixtures of polyvinyl alcohols with different degrees of polymerization, in which case the degrees of polymerization of the individual components may be smaller or greater than the mass-average degree of polymerization, of 150 to 2200, of the mixture.

In some embodiments, suitable PVOH examples include fully hydrolysed polyvinyl acetates, i.e., those having an average degree of hydrolysis of 96.1 to 99.9 mol %, typically having an average degree of hydrolysis of 97.5 to 99.5 mol %, alone or in mixtures with partially hydrolysed polyvinyl acetates, the fully hydrolysed examples typically having a mass-average degree of polymerization of 150 to 2200.

Alternatively, or in addition, in some embodiments it may be useful to employ modified polyvinyl alcohols. For example, these may include PVOH containing functional groups, such as acetoacetyl groups, for example, or PVOH comprising comonomer units, such as vinyl laurate-modified or VERSATIC™ acid vinyl ester-modified polyvinyl alcohols, for example. VERSATIC™ acid vinyl esters are available from Momentive Specialty Chemicals under the trade name VEOVA™, for example VEOVA™ 9 and VEOVA™ 10. Also suitable are ethylene-modified polyvinyl alcohols, which are known, for example, under the trade name EXCEVAL™ polymer (Kuraray America, Inc., Houston, Tex.). These can be used either alone or in combination with standard unsubstituted polyvinyl alcohols. Preferred ethylene-modified polyvinyl alcohols have an ethylene fraction of up to 12 mol %, preferably 1 to 7 mol % and more preferably 2 to 6 mol %; 2 to 4 mol % in particular. The mass-average degree of polymerization is in each case from 500 to 5000, preferably 2000 to 4500, and more preferably 3000 to 4000, based on molecular weight data obtained via Aqueous Gel Permeation Chromatography.

The average degree of hydrolysis is generally greater than 92 mol %, preferably 94.5 to 99.9 mol %, and more preferably 98.1 to 99.5 mol %. Of course, it is also possible, and may be advantageous, to use mixtures of different ethylene-modified polyvinyl alcohols, alone or in combination with partially hydrolysed and/or fully hydrolysed standard polyvinyl alcohols.

The PVOH serving as the emulsion stabilizer will typically be present at a level of 1 to 10 parts per 100 parts of polymer by weight. More typically, the level will be from 2 to 8 parts, or from 4 to 5 parts.

### Preparation of VAE Dispersions

VAE dispersions stabilized with polyvinyl alcohol may be prepared by emulsion polymerization, typically at a temperature in a range from 40° C. to 100° C., more typically 50° C. to 90° C. and most typically 60° C. to 80° C. The polymerization pressure is generally between 40 and 100 bar, more typically between 45 and 90 bar, and may vary particularly between 45 and 85 bar, depending on the ethylene feed. Polymerization may be initiated using a redox initiator combination such as is customary for emulsion polymerization.

Redox initiator systems may be used to prepare VAE emulsions suitable for use according to the invention. The initiators may be formaldehyde-generating redox initiation systems such as sodium formaldehyde sulfoxylate. In some embodiments, however, it is desirable to minimize the formaldehyde level in the dispersion and therefore in the VAE bound nonwoven substrate. In such cases, it is desirable to use a VAE prepared with a non-formaldehyde generating redox initiation system. In general, suitable non-formaldehyde generating reducing agents for redox pairs include, as non-limiting examples, those based on ascorbic, bisulfite, erythorbate or tartaric chemistries as known in the art, and a commercial reducing agent known as BRUGGOLITE® FF6M manufactured by Bruggeman Chemical of Heilbronn, Germany. Non-redox initiators may also be used, such as persulfates, peroxides and azo-type initiators, all of which are well known in the art.

During polymerization the dispersion may be stabilized with polyvinyl alcohol (PVOH) or a combination of PVOH and a surfactant (emulsifier). The polyvinyl alcohol is present during the polymerization generally in an amount totalling 1% to 10% by weight, preferably 2% to 8% by weight, more preferably 4% to 5% by weight, based in each case on the total weight of the monomers.

It is preferable not to add emulsifiers in the polymerization for making the dispersion. In exceptional cases it can be advantageous to make concomitant use of small amounts of emulsifiers, typically from 1 to 5% by weight, based on the amount of monomer. Suitable emulsifiers are either anionic or cationic or nonionic emulsifiers, for example anionic surfactants, such as alkyl sulfates whose chain length is from 8 to 18 carbon atoms, alkyl or alkylaryl ether sulfate having from 8 to 18 carbon atoms in the hydrophobic radical and up to 40 ethylene oxide or propylene oxide units, alkyl- or alkylaryl-sulfonates having from 8 to 18 carbon atoms, esters and half-esters of sulfosuccinic acid with monohydric alcohols or alkylphenols, or nonionic surfactants, such as alkyl polyglycol ethers or alkylaryl polyglycol ethers having from 8 to 40 ethylene oxide units. Preferred are nonionic, ethoxylated emulsifiers with a branched or linear alkyl radical or in the form of ethylene oxide-propylene oxide copolymers. Preferably, these surfactants do not contain alkyl phenol ethoxylate structures and are not endocrine disruptors.

All of the monomers may form an initial charge, or all of the monomers may form a feed, or portions of the monomers may form an initial charge and the remainder may form a feed after the polymerization has been initiated. The feeds may be separate (spatially and chronologically), or all or some of the components may be fed after pre-emulsification. Once the polymerization process has ended, post-polymerization may be carried out using known methods to remove residual monomer, one example of a suitable method being post-polymerization initiated by a redox catalyst. Volatile residual monomers may also be removed by distillation, preferably at subatmospheric pressure, and, where appropriate, by passing inert entraining gases, such as air, nitrogen, or water vapor, through or over the material.

The solids content of suitable VAE dispersions are typically in a range from 45% to 75% by weight, but dispersions with other solids levels may be used.

### Acids

One or more acids are formulated with the PVOH-containing VAE composition to provide increased wet strength. Acid catalysts known in the art to promote self crosslinking of NMA-containing polymers are typically suitable. Suitable acids include organic acids such as acetic acid or citric acid. In some embodiments, mineral acids or other inorganic or non-carboxylic acids are used. Nonlimiting examples include hydrochloric, nitric, sulfuric, phosphoric, and perchloric acid. Partial alkali metal or ammonium salts of di- or tri-protic acids may also be used. Nonlimiting examples include sodium, potassium and ammonium bisulfate, and monosodium, monopotassium and monoammonium phosphate.

Salts formed by reaction of acids with fugitive bases, such as ammonium chloride, in which the ammonia evaporates in use and leaves the acid (HCl) behind in the treated nonwoven, are considered to be catalytic acids for purposes of the invention. Reference to the pKa of such a salt will be understood to refer to the pKa of the acid itself (e.g., HCl, in the case of ammonium chloride). Nonlimiting examples of such acids include ammonium sulfate, ammonium chloride, and ammonium phosphate. In some embodiments, the pKa of the acid is at most 4.0, or at most 3.5, or at most 2.5, or at most 2.0.

Polymeric carboxylic acids are not suitable catalytic acids for purposes of the invention. Thus, for example, homopolymers or copolymers containing acrylic acid, maleic acid or fumaric acid units are not suitable catalysts according to the invention, and thus these and/or other polymeric carboxylic acids may in some embodiments be excluded from the compositions of this invention.

The amount of acid in the formulation will typically be at least 0.1 parts, or at least 0.2 parts, or at least 0.5 parts, or at least 1 part, measured as dry parts based per 100 parts of dry VAE polymer. Typically the amount will be at most 5 parts, or at most 4 parts, or at most 3 parts, or at most 2 parts. In the systems tested here, wet strength is expected to level out with inclusion of 1 to 3 parts of acid.

The acid may be formulated with the dispersion, or it may be added separately to a substrate treated with the dispersion, either before or after drying the dispersion on the substrate.

### Treatment of Nonwoven Substrates

The binder composition is typically applied to a nonwoven substrate via spray application, saturation, gravure printing or foaming. The formulation is typically applied at a solids level between 0.5 to 30% depending on the desired add-on, and typically contains the optional acid (if used). After the formulation is applied to the substrate, the substrate is dried. This is typically done at a temperature in a range from 120° C. to 160° C., but higher or lower temperatures may, be used. A wetting additive can also be included in the treatment composition to aid in the wetting of not only the formulated binder on the substrate, but also wetting of the subsequent finished fibrous nonwoven substrate. One example is AEROSOL® OT, a sodium dioctyl sulfosuccinate. The wetting agent can be added into the formulation at level of 0.1 to 3 dry parts based on the weight of dry polymer but is more typically formulated at between 0.5 and 2 parts.

An alternative application method is to first apply the dispersion to the nonwoven substrate (with or without the wetting additive) and dry the binder on the substrate, and then apply the acid alone to the dried, VAE bound nonwoven and again dry the substrate. For each drying step individually, the temperature is typically in a range from 120° C. to 160° C., but higher or lower temperatures may be used.

The fibrous material used in the nonwoven substrate can be a natural fiber such as (but not limited to) cellulose fiber, or a synthetic fiber including but not limited to one or more of polyester, polyethylene, polypropylene and polyvinyl alcohol, or viscose fiber, or a combination of any of these. The fibrous nonwoven substrate itself can be produced according to any of various methods known in the art, including but not limited to airlaid, wet laid, carding, and hydroentanglement.

As seen in the following examples, excellent wet strength performance may be obtained using the compositions and methods of the invention.

By using a dispersion according to the invention, it is possible to obtain good wet strength performance with reduced generation of formaldehyde because the polymer contains only a low level methylol groups, the main source of formaldehyde in VAE-type binder compositions. The other common source of formaldehyde results from the use of a sodium formaldehyde sulfoxylate redox initiation system in the polymerization reaction used to make the dispersion. In some embodiments of the invention, therefore, it is desirable to further reduce formaldehyde generation by using a formaldehyde-free polymerization initiator for making the dispersion.

The surprising and unexpected high level of wet tensile performance comes despite the very low levels of the self crosslinking monomer, NMA, in the polymer backbone. These results however can only be achieved if the VAE/NMA polymer is stabilized with polyvinyl alcohol or has polyvinyl alcohol as part of the stabilization in combination with a surfactant. And because the NMA is at such low levels, the formaldehyde generation in the dispersion and in the resulting nonwoven is very low.

The invention also encompasses a nonwoven article bound with the polymer dispersion. Preferably, the difference in formaldehyde level between the treated article and an untreated but otherwise analogous article is less than 3 ppm, or less than 1 ppm, measured according to ISO 14184-1 “Textiles—Determination of formaldehyde. Part 1 Free and hydrolyzed formaldehyde (water extraction method)” dated Dec. 15, 1998. In other words, treatment with the binder adds less than 3 ppm, or less than 1ppm, of formaldehyde content to the article.

The following examples illustrate the benefits of using the compositions and methods of the invention.

### EXAMPLES

### Dispersion 1

The following ingredients were mixed together: 652.4 g of CELVOL® 205 (a 10% solution of poly(vinyl alcohol), average hydrolysis level of 87-89%, 4% solution viscosity of 5.2-6.2 cps in water, available from Celanese, Dallas, Tex.), 321.4 g of CELVOL® 513 (a 10% solution of poly(vinyl alcohol) having an average hydrolysis level of 86-89% and a 4% solution viscosity of 13-15 cps in water), and 0.73 g of sodium citrate dissolved in 5.0 g of water. The pH of this mixture was adjusted to 4.1 using 4.7 g of a citric acid solution (50% in water), and 2.1. g of a ferrous ammonium sulfate solution (5% in water) was then added to the mixture. This mixture was added to a one gallon pressure reactor that had been purged with nitrogen, and 1100.0 g of vinyl acetate was added with agitation (200 rpm).

The reactor was purged with ethylene, the agitation was increased to 1000 rpm, and 245 g of ethylene was added to the reactor. The temperature was then increased to 32° C., and 7.3 g of a 1.95% aqueous sodium erythorbate solution (pH adjusted to 5.0 with citric acid) was added to the reactor. A solution of 0.5% aqueous hydrogen peroxide was continuously fed to the reactor at a rate of 0.2 g/min. After the temperature rose 1° C., the 1.95% solution of sodium erythorbate was continuously fed to the reactor at 0.2 g/min, the reactor temperature was allowed to increase to 85 ° C. over 80 minutes, and an additional 278.0 g of vinyl acetate monomer was fed to the reactor over 90 minutes at a rate of 3.09 g/min. In addition, a total of 127.7 g of a 1.3% aqueous solution of a 1:1 molar ratio mixture of NMA and acrylamide was fed to the reactor over 90 minutes. The addition rate was 1.82 g/min for the first 47 minutes and 0.90 g/min for the next 47 minutes.

The hydrogen peroxide and sodium erythorbate feeds were maintained at equal flow rates and adjusted so that the 85 ° C. reaction temperature was maintained. The unreacted vinyl acetate was measured during the course of the reaction and found to be 24.2% after 1 h, 21.2% after 2 h, 3.3% after 3 h, and 1.9% after 3.5 h. At the end of 3.5 h, the hydrogen peroxide and sodium erythorbate feeds were stopped, the reaction was cooled to 60 ° C. and the reaction mixture was transferred to a degasser to remove unreacted ethylene. A mixture of 1.5 g of RHODOLINE® 675 defoamer (Rhodia, New Brunswick, N.J.) and 5 g of water were added to inhibit foam formation. In order to reduce unreacted vinyl acetate monomer below 0.1%, 90.0 g of the 1.95% aqueous sodium erythorbate solution and 141.0 g of 1.0% aqueous tert-butyl hydroperoxide solution were added over 30 minutes. Finally, 14.6 g of a 7.0% aqueous hydrogen peroxide solution was added over 15 minutes.

The final properties of the dispersion were as follows:

| Solids: | 46.7% | |
|---|---|---|
| Viscosity (60 rpm): | 119 | cps |
| Tg (onset): | 8.8° | C. |
| Grit (100 mesh): | 46 | ppm |

### Dispersion 2

Dispersion 2 was made in substantially the same way as Dispersion 1.

### Dispersion 3

Another dispersion was produced in the manner described in Dispersion 1, except that 973.8 g of CELVOL® 205 was used to stabilize the dispersion in place of the combination of CELVOL® 205 and CELVOL® 513 used in Dispersion 1.

The final properties of this dispersion were as follows:

| Solids: | 50.8% | |
|---|---|---|
| Viscosity (60 rpm): | 200 | cps |
| Tg (onset): | 11.5° | C. |
| Grit (100 mesh): | 2 | ppm |

### Dispersion 4

This dispersion was prepared by the same method as Dispersion 3, with the exception that 9.72 g of a 1:1 molar mixture of NMA and acrylamide was added as a 10.8% aqueous solution and a total of 1592 g of vinyl acetate and ethylene was used. The resulting dispersion had a 0.36 wt % NMA content based on vinyl acetate and ethylene.

### Dispersion 5

The following ingredients were mixed together: 1000.0 g of deionized water, 12.0 g of AEROSOL® MA-80-I (an 80% solution of sodium dihexyl sulfosuccinate in alcohol and water) and 0.5 g of sodium acetate. The pH of this mixture was adjusted to 4.5 using 0.45 g of acetic acid, and 5.0 g of a ferrous ammonium sulfate solution (1% in water) was then added to the mixture. This mixture was added to a one gallon pressure reactor that had been purged with nitrogen, and 259.0 g of vinyl acetate was added with agitation (200 rpm).

The reactor was purged with ethylene, the agitation was increased to 900 rpm, and 225 g of ethylene was added to the reactor. The temperature was then increased to 55° C. A solution of 3.75% aqueous ammonium persulfate and a solution of 2.25% aqueous sodium erythorbate were each continuously fed to the reactor at a rate of 0.3 g/min. After the temperature rose 1° C., the reactor temperature was allowed to increase to 85° C. over 30 minutes, and an additional 1467.0 g of vinyl acetate monomer was fed to the reactor over 120 minutes at a rate of 12.2 g/min. In addition, a 320.5 g of an aqueous solution containing 1.97 g of a 1:1 molar mixture of N-methylol acrylamide and acrylamide, 48.9 g of RHODAPON® UB (a 30% aqueous solution of sodium laurel sulfate available from Rhodia) and 23.0 g of AMPS® 2403 (a 50% aqueous solution of the sodium salt of 2-acrylamido-2-methylpropane sulfonic acid, Lubrizol Corporation, Wickliffe, Ohio) was fed to the reactor over 135 minutes.

The ammonium persulfate and sodium erythorbate feeds were maintained at equal flow rates and adjusted so that the 85° C. reaction temperature was maintained. The unreacted vinyl acetate was measured during the course of the reaction and found to be 6.9% after 1 h, 6.6% after 2 h, and 1.9% after 2.5 h. At the end of 2.5 h, the ammonium persulfate and sodium erythorbate feeds were stopped, the reaction was cooled to 50° C. and the reaction mixture was transferred to a degasser to remove unreacted ethylene. A mixture of 1.0 g of FOAMASTER® VF defoamer (BASF Dispersions and Pigments, Charlotte, N.C.) and 5 g of water were added to inhibit foam formation. In order to reduce unreacted vinyl acetate monomer below 0.1%, 20.0 g of a 10.0% aqueous sodium erythorbate solution and 30.0 g of 4.4% aqueous Cert-butyl hydroperoxide solution were added over 15 minutes.

The final properties of the dispersion were as follows:

| Solids: | 55.9% | |
|---|---|---|
| Viscosity (60 rpm): | 396 | cps |
| T_{g} (onset): | 18.7° | C. |
| Grit (100 mesh): | 36 | ppm |

### Commercial Dispersion

A commercially available prior art dispersion was provided for comparison purposes. This dispersion was a surfactant stabilized VAE with 77% by weight of vinyl acetate and 14% by weight of ethylene and with 4.8% by weight of a 1 to 1 molar blend of NMA and acrylamide. Stabilization was with 2.5% by weight of surfactant relative to polymer, and the solids content of the dispersion was 52%.

### Binder Study

Binders suitable for spray application to an airlaid nonwoven substrates were prepared by blending the following, producing a 20% nonvolatile's composition:

| Component | Dry Parts |
|---|---|
| VAE | 100 |
| Ammonium chloride | 0/1 |
| Wetting surfactant | 1 |
| (AEROSOL ® AOT) | |

The binder formulations were spray applied to a 90 gsm airlaid substrate having 88 wt % cellulose fibers and 12 wt % synthetic bi-component fibers consisting of a polyester core and a polyethylene sheath. The formulation was applied at a targeted add-on of 20% by weight (dry dispersion on dry substrate). The binder was dried in a Mathis oven at 150° C. for 3 minutes. The dried substrates were conditioned overnight in a constant temperature and humidity room at 72° F. and 50% relative humidity. After conditioning overnight, the substrates were tested for wet and dry breaking tensile strength using an Instron tensile tester following ASTM method D 5035-95.

Table 1 illustrates the wet and dry tensile breaking strengths of the above mentioned airlaid substrates using the dispersions described above, as well as the formaldehyde levels present in each dispersion.

TABLE 1

| | | | | | Substrate | Dry | Wet | | 50% Solids |
|---|---|---|---|---|---|---|---|---|---|
| | | | Self | | Basis | Tensile | Tensile | % Wet Tensile | Dispersion |
| | | | Crosslinking | | Weight | Strength | Strength | Increase with | Formaldehyde |
| Example | | Polymer | Monomer | Add-on | grams/ | grams/ | grams/ | NH₄Cl vs. | Level |
| No. | Composition | Stabilization | Level | % | sq. meter | 5 cms | 5 cms | without NH₄Cl | (ppm) |
| 1 | Commercial | Surfactant | 2.80% | 19.8 | 101.5 | 3410 | 1654 | 13.0% | 52.5 |
| | w/0 parts NH₄Cl | | | | | | | | |
| 2 | Commercial | Surfactant | 2.80% | 19.6 | 103.2 | 3424 | 1869 | | |
| | w/1 Part NH₄Cl | | | | | | | | |
| 3 | Dispersion 4 | PVOH | 0.36% | 19.9 | 100.1 | 3057 | 921 | 44.5% | 15.2 |
| | w/0 Parts NH₄Cl | | | | | | | | |
| 4 | Dispersion 4 | PVOH | 0.36% | 18.4 | 99.3 | 3355 | 1331 | | |
| | w/1 Part NH₄Cl | | | | | | | | |
| 5 | Dispersion 1 | PVOH | 0.06% | 19.5 | 103.9 | 3163 | 741 | 63.8% | 3.6 |
| | w/0 Parts NH₄Cl | | | | | | | | |
| 6 | Dispersion 1 | PVOH | 0.06% | 18.8 | 100.7 | 3047 | 1214 | | |
| | w/1 Part NH₄Cl | | | | | | | | |
| 7 | Dispersion 5 | Surfactant | 0.06% | 19.2 | 104.4 | 2431 | 735 | 1.0% | N/A |
| | w/0 Parts NH₄Cl | | | | | | | | |
| 8 | Dispersion 5 | Surfactant | 0.06% | 18.3 | 104.6 | 2225 | 742 | | |
| | w/1 Part NH₄Cl | | | | | | | | |

As seen in Table 1, the nonwovens bound with PVOH stabilized VAE and a low level of NMA and formulated with ammonium chloride (Example 4) had wet tensile strength at a 71% level relative to the prior art commercial dispersion (Example 2), despite having only 13% as much of the monomer (NMA) responsible for providing wet strength. A reduced level of formaldehyde was produced. At a yet lower level of NMA, i.e., only about 2% of the amount in the commercial dispersion, Example 6 showed 65% of the wet tensile strength of the latter. At the same time, formaldehyde content was drastically reduced from 52.5 ppm to 3.6 ppm, a 93% reduction. In the absence of catalytic ammonium chloride, however, the PVOH stabilized dispersions with low NMA content showed severe drops in wet tensile, while the commercial dispersion retained 88% of its value.

Unlike the PVOH-stabilized low NMA dispersions, the surfactant-stabilized low NMA dispersion showed no improvement with addition of ammonium chloride, and provided only very low wet tensile strength. Thus, both PVOH stabilization and acid catalysis (e.g., ammonium chloride) were necessary to provide suitably high wet tensile strength with a low NMA dispersion. Very low formaldehyde levels were simultaneously achieved in such systems.

The use of an acid catalyst to promote or catalyze the self-crosslinking reaction of polymers containing N-methylol acrylamide is well documented. Surprisingly, however, the increase in the wet tensile strength of the nonwoven bound with the PVOH stabilized VAE having very low levels of NMA and formulated with the ammonium chloride is substantially higher on a percentage basis than that obtained with the surfactant stabilized commercial dispersion, which contained more than 40 times the amount of NMA. If the combination of acid catalyst and NMA alone had been responsible for the wet tensile increase in Examples 4 and 6 vs. Examples 3 and 5 respectively, then the commercial dispersion with the 40× amount of NMA should have provided a much larger percentage increase in wet tensile strength when formulated with ammonium chloride (acid). This was not observed. Thus, it appears that the unexpected increase in wet tensile strength observed with Examples 4 and 6 was due to a combination of polyvinyl alcohol stabilization of the VAE dispersion and the presence of an acid catalyst, largely compensating for the several-fold reduction in NMA content.

Further examples of this are shown in Table 2 below. Here, Examples 11 through 14 illustrate the nonwoven properties of airlaid substrates bound with PVOH stabilized VAE's having 0.06% NMA on VAE. Dispersion 2 (Examples 11 and 12) used a combination of low and medium molecular weight, partially hydrolyzed (88% hydrolysis) PVOH as the emulsion stabilizer, while Dispersion 3 used only low molecular weight, partially hydrolyzed PVOH as the stabilizer.

As before, the PVOH stabilized VAE's formulated with ammonium chloride (Examples 12 and 14) provided the nonwoven with a substantial increase in wet tensile strength vs. the nonwoven bound with the same VAE's without the ammonium chloride catalyst (Examples 11 and 13 respectively). As before, the percentage increase in the nonwoven wet tensile bound with the PVOH stabilized VAE with the low NMA level and formulated with the ammonium chloride versus that without the ammonium chloride (Examples 11/12 and 13/14 respectively) was much greater than for the commercial dispersion (Example 9/10).

TABLE 2

| | | | | | Substrate | Dry | Wet | | 50% Solids |
|---|---|---|---|---|---|---|---|---|---|
| | | | Self | | Basis | Tensile | Tensile | % Wet Tensile | Dispersion |
| | | | Crosslinking | | Weight | Strength | Strength | Increase with | Formaldehyde |
| Example | | Polymer | Monomer | Add-on | grams/ | grams/ | grams/ | NH₄Cl vs. | Level |
| No. | Composition | Stabilization | Level | % | sq. meter | 5 cms | 5 cms | without NH₄Cl | ppm |
| 9 | Commercial | Surfactant | 2.80% | 19.2 | 105.1 | 3550 | 1794 | 0.0% | 52.5 |
| | w/0 parts NH₄Cl | | | | | | | | |
| 10 | Commercial | Surfactant | 2.80% | 19.0 | 102.3 | 3399 | 1788 | | |
| | w/1 part NH₄Cl | | | | | | | | |
| 11 | Dispersion 2 | PVOH | 0.06% | 19.7 | 106.2 | 3478 | 678 | 82.0% | 5.9 |
| | w/0 Parts NH₄Cl | 88% hydrolysis | | | | | | | |
| | | Low/medium MW | | | | | | | |
| 12 | Dispersion 2 | PVOH | 0.06% | 19.6 | 101.2 | 3474 | 1234 | | |
| | w/1 Part NH₄Cl | 88% hydrolysis | | | | | | | |
| | | Low/ medium MW | | | | | | | |
| 13 | Dispersion 3 | PVOH | 0.06% | 19.4 | 100.1 | 3083 | 824 | 48.0% | 5.1 |
| | w/0 Parts NH₄Cl | 88% hydrolysis | | | | | | | |
| | | Low MW | | | | | | | |
| 14 | Dispersion 3 | PVOH | 0.06% | 19.4 | 103.7 | 3258 | 1226 | | |
| | w/1 Part NH₄Cl | 88% hydrolysis | | | | | | | |
| | | Low MW | | | | | | | |

As the foregoing results demonstrate, compositions according to the invention are capable of providing high levels of wet strength despite while producing only very low levels of formaldehyde.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. An aqueous composition comprising a blend of:
a) an aqueous dispersion of an N-methylol-containing vinyl acetate ethylene or vinyl acetate polymer, stabilized by polyvinyl alcohol and optionally also by a surfactant, wherein N-methylol-containing monomer units constitute from 0.025 to 0.4 wt % of the polymer; and
b) an acid.

2. The composition of claim 1, wherein the acid is a mineral acid or an ammonium salt thereof.

3. The composition of claim 2, wherein the ammonium salt is present and is ammonium chloride.

4. The composition of claim 1, wherein the polymer is a vinyl acetate ethylene copolymer.

5. The composition of claim 1, wherein the N-methylol-containing monomer units comprise N-methylolacrylamide units.

6. The composition of claim 1, wherein the polymer further comprises acrylamide units.

7. The composition of claim 1, wherein the surfactant is present.

8. A method of increasing the wet strength of a fibrous nonwoven substrate, comprising applying to the substrate the aqueous composition of claim 1, followed by a drying step.

9. The method of claim 8, wherein the acid is a mineral acid or an ammonium salt thereof.

10. The method of claim 9, wherein the acid is ammonium chloride.

11. The method of claim 8, wherein the N-methylol-containing monomer units comprise N-methylolacrylamide units.

12. The method of claim 8, wherein the polymer further comprises acrylamide units.

13. The method of claim 8, wherein the surfactant is present.

14. The method of claim 8, wherein the drying step is performed at a temperature in a range from 120° C. to 160° C.

15. A fibrous nonwoven article made by the method of claim 8.
